(19) United States
(12) Patent Application Publication
(10) Pub. No.: US 2003/0132552 A1
(43) Pub. Date: Jul. 17, 2003

(54) PROCESS FOR CONTROLLING THE MANUFACTURING OF DIMENSIONALLY VARYING TUBULAR MEMBERS

(76) Inventors: JONATHAN D. GAMBLE, MINNEAPOLIS, MN (US); KEITH O'BRIEN, MENDOTA HEIGHTS, MN (US); JAMES W. KIMMET, PLYMOUTH, MN (US); PATRICK J. PIATZ, CAMBRIDGE, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 09/573,742

(22) Filed: May 18, 2000

(51) Int. Cl. B29C 47/92

(52) U.S. Cl. 264/407; 264/40.1; 264/40.7; 264/159

(57) ABSTRACT

A system for controlling the manufacture of dimensionally varying tubular members extrudes a continuous tube with a lumen from an extrusion machine. The extrusion machine has a melt pump, which regulates the flow rate of the melt through the extrusion head. The extrusion head forms a melt flow and introduces air pressure within the melt flow to form the lumen of the tubing. An air pressure regulator controls the pressure of the air introduced through the extrusion head. A puller supplies tension to the tubing as it is extruded through the extrusion head. The system uses a diameter gage and/or a wall thickness gage to measure the change in the wall thickness of the tubing as a function of its length. Further, the system uses a laser to gage the profile of the tubing. The system automatically compares the measured dimensions against stored dimension targets to generate feedback to the components of the extrusion machine, automatically adjusting one or more process variables for the next tubular member in the extrusion sequence. Finally, the system sorts the tubular members that fall within acceptable error margins, and sorts out those that fall outside the error margins.

### CROSS-REFERENCE TO RELATED APPLICATION(S)

None.

### BACKGROUND OF THE INVENTION

The present invention relates to a system for controlling the manufacturing of dimensionally varying tubular members. In particular, the present invention relates to a system for extruding dimensionally correct tubular members having varying dimensions along the length of each tubular member.

The mechanism for extruding the tubular member is known in the art. The extrusion mechanism includes at least an extruder such as the extruders produced by Davis-Standard in Pawtucket, Conn., an extrusion head, an air pressure regulator, and a puller/cutter. The system may contain a melt pump which pushes a melt through the extrusion head. The melt is typically comprised of a thermoplastic. The melt extrudes around the head, and the air pressure regulator pushes air or a similar gas through the extrusion head creating an extrusion with a lumen. The puller produces a tension on the extrusion, stressing the extruded melt material. The cutter cuts the tubing into discrete segments.

Typically, the segments are then measured and analyzed. If analyzation reveals that the measured dimensions are outside of tolerance, a machine operator may adjust the air pressure, the melt pump speed and/or the puller tension on subsequent extrusions. When making a tapered tubing or bump tubing, this process becomes more difficult, because correcting for small dimensional variations requires multiple measurements. Each measurement increases the possibility for introducing human error in the production line.

Present extrusion processes are often susceptible to uncontrolled conditions. For instance, room temperature changes, melt pressure or melt temperature changes may impact the flow volume of the melt. Slight variations in room conditions can have a significant impact on the extrusion. In addition, countless other variables may impact the production process, such as the changing temperature of the extrusion head. Each variable has an impact on the resulting extrusion. Accordingly, some production facilities may include expensive systems to tightly control the extruder environment. Even with a carefully controlled environment, it is difficult to control for every factor that may impact the extrusion process. To obtain a detailed tubing profile with high tolerance, expert extruder operators have been needed. The expert extruder operator uses experience, knowledge and skill in setting and controlling the system. Since conditions and variables may change during the course of production, the expert extruder operator must not only begin the extrusion sequence and initially adjust the extrusion parameters, but may have to repeatedly tweak the extrusion parameters to prevent the dimensions of the extruded parts from changing during the production run. Due to the extrusion process' sensitivity to (often uncontrolled) environmental conditions, it is difficult to meet exacting production tolerance requirements without generating a significant amount of waste.

Current taper tubing extrusion mechanisms lack the capacity to monitor the extruded product automatically. Variations must be corrected manually, and to do so the extruder must be run open-loop, meaning that the extrusion operator must manually take measurements and then make process adjustments. Multiple measurements and adjustments must be made along the length of the tubing. In addition, extra inspection steps may be necessary at the end of the line to ensure a quality product. The operator intensive setup and operation increases production costs, decreases production efficiency and, depending on the operator, may increase the number of parts extruded before the desired tubular member is achieved.

Improvements are needed to reduce the cost and increase the efficiency of the extrusion mechanism and of the process for making dimensionally varying tubular members.

### BRIEF SUMMARY OF THE INVENTION

The present invention is a system for controlling the manufacture of dimensionally varying tubular members. The system extrudes a continuous tube with a lumen from an extrusion machine. The extrusion machine may or may not have a melt pump which regulates the flow rate of the melt through the extrusion head. The extrusion head forms a melt flow and introduces gas pressure within the melt flow to form the lumen of the tubing. A gas pressure regulator controls the pressure of the gas introduced through the extrusion head. A puller supplies tension to the tubing as it is extruded through the extrusion head. The system uses a diameter gage and/or a wall thickness gage to measure the change in the diameter and/or wall thickness of the tubing as a function of its length. In one aspect, the system uses a laser to gage the profile of the tubing at high speed. The system compares the measured dimensions against stored dimension targets to generate feedback to the components of the extrusion mechanism, automatically adjusting one or more process variables for the next tubular member in the extrusion sequence.

### BRIEF DESCRIPTION OF THE DRAWINGS

FIG. 1 is a flow chart of the prior art taper tubular member extrusion process.

FIG. 2 is a flow chart of the extrusion process of the present invention including the feedback loop.

FIG. 3 is a drawing of a dimensionally varying tubular member having a constant external diameter and a varying internal diameter.

FIG. 4 is a drawing of a dimensionally varying tubular member having a varying external diameter and a constant internal diameter.

FIG. 5 is a drawing of a continuos tube with a lumen prior to cutting into the tubular members (shown in FIGS. 3 and 4).

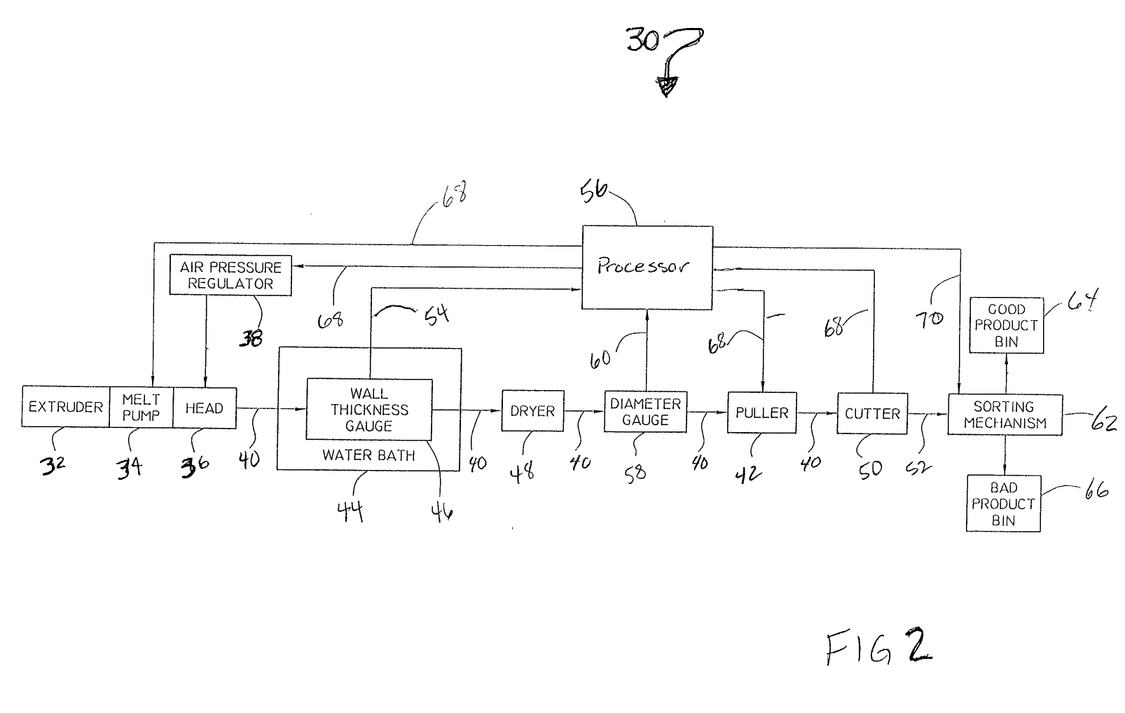

While the above identified FIGS. 2-5 set forth a preferred embodiment of the present invention, other embodiments of the present invention are also contemplated, some of which are noted in the discussion. In all cases, this disclosure presents the illustrated embodiment of the present invention by way of representation, and not limitation. Numerous other minor modifications and embodiments can be devised by those skill in the art which fall within the scope and spirt of the principles of this invention.

### DETAILED DESCRIPTION

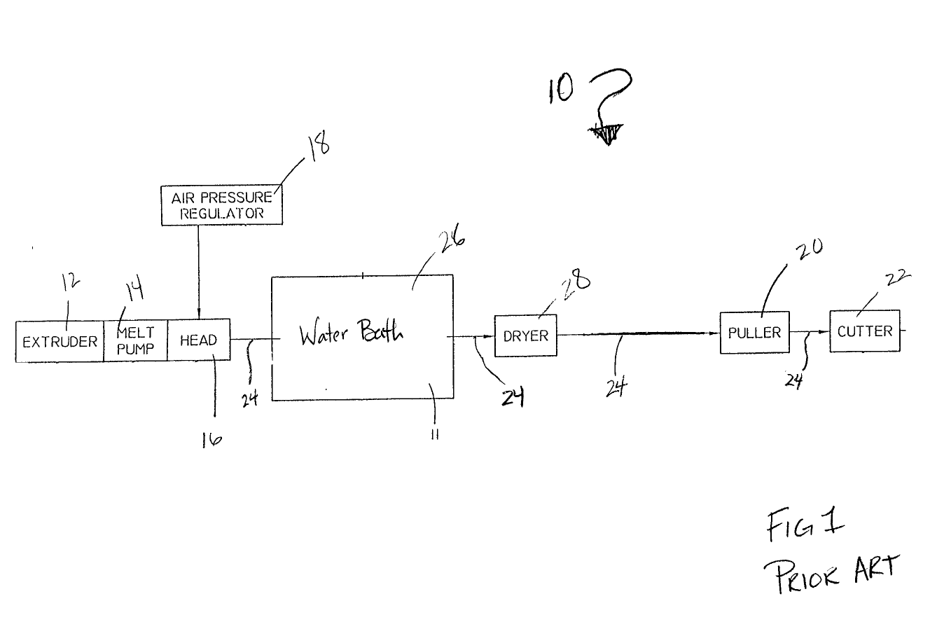

As shown in FIG. 1, a prior art extrusion system 10 includes a number of generally standard components: an extruder 12, a melt pump (optional) 14, an extrusion head 16, an air pressure regulator 18, a puller 20, and a cutter 22. The melt pump 14 forces melt (not shown) through the extrusion head 16. At the same time, the air pressure regulator 18 forces air through the extrusion head 16 and into the melt, thereby forming a tube 24 with a lumen (not shown). The tube 24 may then be pulled by the puller 20 through a water bath 26 for cooling and through a dryer 28. After the tube 24 is dried, it is pulled through the cutter 22. The cutter 22 segments the tube 24 into discrete tubular members (not shown).

In the prior art extrusion system 10, quality control is performed manually. The operator must examine the tubular members and compare them against desired measurements. The operator then adjusts one or more of the component parameters to correct the dimensions of the next tubular member. For instance, the operator may increase the air pressure to increase the inner diameter of the tube 24.

The prior art extrusion system 10 does not provide feedback to the various components automatically. A machine operator must monitor the output of the extrusion system 10, and the extrusion system 10 must been run “open-loop.” An “open-loop” system requires frequent manual measurements to allow the operator to set-up, measure the tube 24 and perform any adjustment of the extrusion parameters.

The prior art extrusion system 10 requires a great deal of operator interaction. Specifically, measurement calibrations and adjustments are made manually, wasting time and melt product and producing tubular members with potentially significant dimensional variation. In addition, at each measurement and adjustment point, another opportunity for human error is introduced into the production process. Tubular members must be manually examined and sorted into separate bins for good and bad tubular members. Due to the time intensive nature of manual adjustments and the potential for introduction of human error, typically a large amount of waste tubing is generated during the production process. As a result, current extrusion systems 10 achieve comparatively low yields and experience extended set up times.

FIG. 2 is a flow diagram of the process of extruding a dimensionally varying tubular member of the present invention. Similar to the prior art system 10, in the extrusion system 30 of the present invention, the extruder 32 may have a melt pump 34, which forces melt around the extrusion head 36.

The melt (not shown) is an extrusion material. The extrusion material need not be flexible in its solid form. The melted extrusion material may consist of any thermally extrudable material. In the preferred embodiment, the melted extrusion material generally consists of one of the following: Polyolefin, polyamide copolymers, polyvinyl chloride, ABS, ionomer, polyester, polyamide, polycarbonate, thermoplastic elastomers, polyurethane, or fluoropolymer. While the present invention is described with reference to the preferred embodiment and particularly with reference to flexible extrusion materials, the extrusion system 30 could be applied to a wide variety of thermally extrudable materials that may or may not be flexible, including metal or glass.

As the melt is forced around the extrusion head 36, the air pressure regulator 38 forces air through the extrusion head 36 forming a tube 40 with a lumen (not shown). A puller 42 places tension on the tube 40 as it is extruded. The puller 42 pulls the tube 40 through a bath 44, where a wall thickness gage 46 (if present) measures the wall thickness along the length of the tube 40. A diameter gauge 58 may measure the outside diameter. Then, the puller 42 pulls the tube 40 through a dryer 48.

The dryer 48 may use contact to remove excess water. In the preferred embodiment, the dryer 48 does not contact the tube 40. Instead, air is used to dry the tube 40. The air may be heated to assist in the drying.

Finally, the tube 40 is pulled into the cutter 50. The cutter 50 segments the tube 40 into discrete tubular members 52. The cutter 50 cuts the tube 40 into a tubular member 52 and sorts the tube 40 into either a good bin 54 or a bad bin 56, according to a signal received from the system processor 56.

The extrusion system 30 generates a continuous length of tube 40 (shown in FIG. 5), which is segmented by the cutter 50 into discrete tubular members 52. The length, outer diameter, and wall thickness of the tubular members 52 are determined by the intended application, and the dimensions may be varied by adjusting any of the process variables for the various components (i.e. the melt pump 32, the air pressure regulator 38, the puller 42, and/or the cutter 50).

The melt pump 34 operates according to a melt pump flow parameter. The melt pump parameter determines the volume of melt which the melt pump 34 forces around the extrusion head 36. The melt pump flow parameter is a first process variable that is initially set by the system operator. The melt pump flow parameter depends primarily on the desired wall thickness and the type of melt material used. In the preferred embodiment, the melt pump flow parameter is a pump speed, which can be adjusted by varying a motor control within the melt pump 34. Generally, a higher melt pump speed results in tube 40 with a thicker wall. Varying the volume output of the melt pump 34 can change the inner or outer diameter of the tube 40, depending on the other process variables. Though not controlled in the preferred embodiment, the temperature of the melt can be controlled as a second process variable, either in addition to or in place of the melt pump flow parameter.

The air pressure regulator 38 operates according to a pressure parameter, which is a process variable initially set prior to extrusion. The air pressure regulator 38 forces air through the extrusion head 36 creating a lumen within the extrusion material. The air pressure parameter may be adjusted as the tube 40 is extruded to vary or maintain the internal diameter of the tube 40 relative to the other dimensions of the tube 40. Generally, a higher air pressure defines a larger internal diameter and a thinner wall thickness, depending on the other process variables.

The puller 42 operates according to a puller parameter, which is a process variable that determines the speed of the tube 40 as it is extruded from the extrusion head 36. The puller 42 tensions the tube 40 as it solidifies. Increasing the puller speed places higher tension on the tube 40, stretching the melt material and establishing a thinner wall thickness. By increasing the puller speed relative to other process variables, the puller 42 can impact the wall thickness and the internal diameter. In the preferred embodiment, the puller parameter is controlled by varying a voltage input to a servo-motor within the puller 42.

The puller 42 pulls the tube 40 through a bath 44. The bath 44 may consist of any fluid substance. In the preferred embodiment, the bath 44 consists of water. The temperature or pressure of the bath 44 may also be controlled as process variables, although the preferred embodiment operates without control of the bath 44 by the processor 56.

As the tube 40 passes through the bath 44, a wall thickness gage 46 measures the thickness of the tube 40. While any gage that can measure the wall thickness of the tube 40 may be used, in the preferred embodiment the wall thickness gage 46 does not contact the surface of the tube 40 because contact may alter or score the surface of the tube 40 before it hardens completely. In the preferred embodiment, the wall thickness gage 46 measures wall thickness ultrasonically.

In the preferred embodiment, the wall thickness gage 46 can take at least 10 measurements per inch, and more preferably nearly 300 measurements per inch when the extrusion system 30 is producing tube 40 at a rate of 200 feet per minute. At slower rates, the wall thickness gage 46 can take up to 1000 measurements per inch. The wall thickness gage 46 thus measures the wall thickness nearly continuously along the length of the tube 40 and sends a wall thickness signal 54 representative of the measured wall thickness at each longitudinal position to the system processor 56.

After the tube 40 passes out of the bath 44, a diameter gage 58 measures the outer diameter of the tube 40 at many longitudinal positions along its length. While any gage that can measure the outer diameter of the tube 40 may be used, in the preferred embodiment the outer diameter is measured using a laser gage 58. Measured optically with a laser gage 58, accurate measurements of outer diameter can be taken, even as the outer profile changes at angles approaching 90 degrees.

The number of measurements per linear inch is extremely important to maintain extrusion production within tight manufacturing tolerances. High measurement rate is needed to capture rapid transitions and tapers.

The extrusion system 30 runs at a rate of 10 feet or more per minute to generate smaller diameter tubing, and perhaps up to a rate of 100 to 200 feet per minute. At 200 feet per minute, tube 40 is extruded from the extrusion system 30 at a rate of 40 inches per second. To extrude tube 40 within error tolerances, the extrusion system 30 must take frequent measurements. In low error tolerance applications, such as medical devices, the tube 40 must meet exacting standards with very small margins of error.

At high speeds, diameter gage 58 speeds become increasingly important. For instance, if the diameter gage operates at 30 scans per second, at extrusion speeds of 200 feet per minute, the diameter gage would take a measurement every 1 and ⅓ inches, creating an error margin of more than plus or minus 1 longitudinal inch for any varying dimension. In addition, if the diameter gage has processing circuitry which averages measurements, even at high scan rates, variations along the length of a taper tube (shown in FIG. 5) cannot be taken with high precision. Significant variations can be overlooked in the averaging.

In the preferred embodiment, the diameter gage 58 is capable of scanning the tube 40 profile at about 2,800 scans per second per axis, such as providing 2,833 measurements per second without averaging. At 200 feet per minute, the laser can measure at a rate of 70.825 measurements per inch without averaging. Depending on the diameter gage 58, the resulting tubular members 52 can achieve error tolerances of less than the measurement gage error tolerances of about plus or minus 1 micron in the transverse direction, while maintaining a longitudinal distance between measurements of 0.014 inches (assuming a 200 feet per second extrusion rate). The diameter gage 58 thus measures the external diameter of the tube 40 nearly continuously along the length of the tube 40 and sends a diameter signal 60 representative of the measured diameter at each longitudinal position to the system processor 56.

The wall thickness gage 46 and the diameter gage 58 provide measurements of the tube 40 at increments of less than 0.5 mm. Such closely spaced measurements allow for nearly immediate feedback if any dimension is out of spec. The feedback loop automatically adjusts one or more process parameters, resulting in production of precise, tapered tube 40 within spec.

A cutter 50 operates according to a cutting parameter. In some embodiments, the cutter 50 may be contained in the puller 42. The cutting parameter is a process variable that is initially set prior to operation of the extrusion system 30. The cutting parameter determines the length of each tubular member 52. The preferred cutting parameter is the timing of the cutter 50. In the preferred embodiment, the cutter 50 cuts the tube 40 at a 90 degree angle relative to the central axis of the tube 40.

After the cutter 50 segments the tube 40 into the tubular member 52 the tubular members 52 enter a sorting mechanism 62. The sorting mechanism 62 sorts the tubular members 52 into two bins: a good product bin 64 and a bad product bin 66. The tubular members 52 that are selected for the good product bin 64 have measured wall thickness, internal and external diameters that fall within acceptable error tolerances throughout their length. In addition, the tubular members 52 have lengths that fall within acceptable error tolerances. The bad product bin 66 contains tubular members 52 that have dimensions falling outside the acceptable error tolerance range.

The acceptable error tolerance varies depending on the application for the tubular member 52. In medical applications, for instance, the error tolerance may be very tight and may require an exact profile to fit a particular need.

In one embodiment, the system processor 56 accepts measurement signals 54,60 from the wall thickness gage 46 and the outer diameter gage 58. The system processor 56 retrieves stored dimensional values representative of the desire tubular member 52. The system processor 56 then compares the measured signals 54,60 against the stored wall thickness values and determines if any differences exist between the measured values and the dimensional targets.

Environmental changes can result in large amounts of waste product, unless the effects are detected in time to properly adjust the extrusion parameters to offset the environmental changes. If differences are detected, the system processor 56 calculates adjustments of one or more of the process parameters, which will correct the difference in the next tubular member in the extrusion sequence. The system processor 56 then generates an adjustment signal 68, which adjusts the parameters for any of the melt pump 34, the air pressure regulator 38, the puller 42 or the cutter 50.

In addition, the system processor 56 generates a signal 70 to the sorting mechanism 62 indicating whether the tubular member 52 should be sorted into the good product bin 64 or the bad product bin 66.

In the preferred embodiment, the system processor 56 sends an individual adjustment signal to each of the melt pump 34, the puller 42, the cutter 50, the air pressure regulator 38, and the sorting mechanism 62. In an alternative embodiment, the adjustment signal 68 generated by the system processor 56 may be a single signal to all of the melt pump 34, the air pressure regulator 38, the puller 42, the cutter 50, and the sorting mechanism 62. The system processor 56 automatically adjusts the components 34,38,42,50 of the extrusion system 30 such that the next tubular member 52 will have adjusted dimensions. The adjustment process is repeated iteratively through out the extrusion process.

The system processor 56 provides feedback to the components 34,38,42,50, which allows for continuous adjustments in the extrusion process to achieve and maintain product 52 that meets specifications. The feedback loop allows the adjustment process to be automated. The extrusion system 30 produces higher quality parts with tighter tolerances, and higher yields with shorter start up or set up times. Using the measurement devices 46,58, the system 30 is able to calculate and implement a controlled feedback loop to achieve a product 52 with varying dimensions. Further, the feedback loop reduces the amount of wasted tube 40 generated by the extrusion system 30, by adjusting parameter variables during production to maintain products 52 within acceptable error margins.

Generally, the cutter 50, the puller 42, the melt pump 34, and the air pressure regulator 38 work together to produce a particular tubular member 52. The cutter variable determines the length of the tubular member 52 while the puller speed, the air pressure, and the melt pump speed combine to determine the wall thickness, the internal and the external diameters. For example, if the melt pump speed is kept constant, but the puller speed is increased and air pressure is increased, the tube 40 will have a relatively thin wall thickness relative to the tube 40 prior to that adjustment. If the air pressure is held constant and the melt pump speed and the puller speed are increased, the internal diameter will decrease and the wall thickness will increase.

The extrusion system 30 of the present invention is capable of producing tubular members 52 of varied dimensions. For example, FIG. 3 illustrates a tubular member 52 having a lumen 72. The tubular member 52 illustrates a constant external diameter (De) and a varying wall thickness (T, T₁) and internal diameter (Di, Di₁). Internal diameter (Di, Di₁) of the tube 40 is adjusted dynamically along the length of the tube 40. Here, the wall thickness (T, T₁) could be affected by maintaining a constant puller tension, while changing the melt pump speed and the air pressure rate.

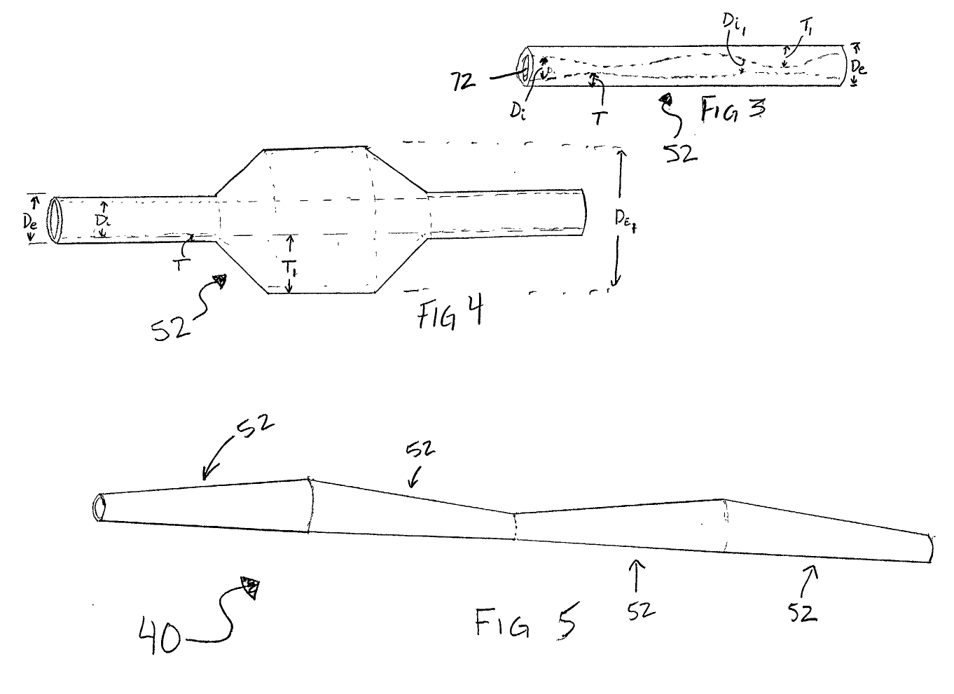

FIG. 4 illustrates a tubular member 52 having a constant internal diameter (Di) and varying external diameter (De, De₁) and wall thickness (T, T₁). The external diameter (De, De₁) and wall thickness (T, T₁) change along the length of the tubular member 52. In this instance, the air pressure would have to adjust proportionally to the puller tension and the melt pump speed to maintain a constant internal diameter (Di).

FIG. 5 illustrates a tube 40, prior to cutting, where the tube 40 tapers along its length. Each uncut tubular member 52 has a changing external profile. The internal dimensions (not shown) may vary. Numerous other tapers or shapes of tubular members 52 could be conceived by someone skilled in the art, but are not illustrated here, including a tubular member 52 having concentric ridges (not shown), formed by oscillating the speed of the melt pump 34 while holding the air pressure and puller tension constant.

If the tube 40 in FIG. 5 maintained a constant internal diameter, both the wall thickness and the external diameter would change. In such an example, the melt pump speed might be held constant while the puller tension and the air pressure were adjusted. The puller tension would stretch the extrusion, and the combination of increased air pressure and increased tension would result in a thinner wall thickness. As the puller tension is decreased along with the air pressure, the wall thickness would increase, resulting in a taper effect. The puller tension may increase the pressure on the lumen of the tube 40, requiring adjustments in the air pressure to maintain constant internal diameter. Tubular members 52 are extruded from start to finish and then from finish to start because the wall thickness, internal diameter and profile would be the same at adjoining points. By producing lengths of tube 40 in this way, waste of extrusion material is minimized.

Many alternative tubular member 52 shapes, diameters, or other dimensions can be created with this extrusion system 30. The extrusion system 30 is particularly applicable for use on production lines with more than one shape of tubular member 52 being extruded in sequence at the same time.

At production speeds of 200 feet per second, the diameter gage 58 and the wall thickness gage 46 of the preferred embodiment take measurements every 0.014 inches. If a dimensional aberration fell between measurements, it might not be detected by the two gages. In order to fall between measurements, such a variation would have to fall within an area smaller than 0.014 inches.

Typically, the present invention operates at nearly 200 feet per minute in a production cycle. Some commercially available gages take measurements at approximately 0.5 scans per second. Other manufacturers provide gages that operate close to 30 measurements per second. The present invention employs a diameter gage 58 capable of taking 1833 to 2833 measurements per second without averaging and with measurement error margins smaller than 1 micron. Further, the gages allow for even more measurements per inch at slower speeds.

In addition, in the preferred embodiment, the diameter gage 58 and the wall thickness gage 46 are both capable of taking measurements even at a wall diameter change approaching 90 degrees.

While the present invention is described with reference to an ultrasonic wall thickness gage 46, other wall thickness gages are anticipated. Ultrasonic gages must be calibrated to the type of material being used, and there is a ranges outside of which the ultrasonic gage will not work. Typically, an ultrasonic gage works within the range of 0.001 inch to one-quarter of an inch of thickness. However, capacitive gages can be used to measure wall thickness in certain embodiments.

In the preferred embodiment, the bath 44 is a water bath 44; however, any fluid bath 44 may suffice. Also, a dryer 48 may not be needed.

Although the present invention has been described with reference to preferred embodiments, workers skilled in the art will recognize that changes may be made in form and detail without departing from the spirit and scope of the invention.

1. A method for controlling the manufacture of dimensionally varying tubular members, the method comprising:
extruding a continuous tube with a lumen from an extrusion machine, the continuous tube comprising discrete, substantially identical tubular members in an extrusion sequence, each tubular member having inner diameter and outer diameter and a length, with a wall thickness between the inner diameter and the outer diameter, at least one of the inner diameter and the outer diameter varying as a function of the length, the extrusion machine comprising:
an extrusion head forming a melt flow and introducing a fluid within the melt flow to form the lumen of the tube;
a fluid pressure supplier which controls pressure of the introduced fluid;
a puller which supplies tension to the tube; and
a melt pump which regulates flow rate of the melt flow through the extrusion head;
measuring at least one of inner diameter, outer diameter and wall thickness along the length of the tubular member to determine measured dimensions for the tubular member;
comparing the measured dimensions against stored dimension targets to generate an adjustment signal; and
adjusting automatically one or more process variables for a next tubular member in the extrusion sequence according to the adjustment signal.

2. The method of claim 1 wherein the machine comprises a cutter which cuts the tube into the tubular members, the cutter having a cutting parameter; and
wherein the adjusting act comprises,
adjusting the cutting parameter for the next member; and
wherein the method further comprises,
cutting the tube into discrete, substantially identical tubular members.

3. The method of claim 1 wherein the measuring act comprises:
cooling the tube in a bath; and
gauging the wall thickness without contacting the tube.

4. The method of claim 3 wherein the measuring act further comprises:
gauging the wall thickness ultrasonically.

5. The method of claim 1 wherein the comparing act comprises:
calculating differences between the measured dimensions and the stored dimension targets;
calculating changes necessary to reduce the differences; and
generating the adjustment signal.

6. The method of claim 5 wherein the comparing act further comprises:
sorting tubular members into good tubular members or bad tubular members according to the stored dimension targets and according to stored error tolerances, the good tubular members having calculated measurement errors less than the stored error tolerances, the bad tubular member having calculated measurement errors greater than the stored error tolerances; and
removing the bad tubular members from the extrusion sequence.

7. The method of claim 2 wherein the adjusting act comprises,
processing the adjustment signal into discrete feedback adjustment signals;
adjusting automatically any of the melt flow, the pressure, the tension, the flow rate, and the cutting parameter according to the feedback adjustment signals.

8. The method of claim 7 wherein the adjusting act further comprises,
adjusting automatically according to adjustment signals representative of the measured dimensions measured in real time.

9. The method of claim 1, wherein the melt flow comprises a flexible thermoplastic.

10. The method of claim 1, wherein the machine comprises a cutter which cuts the tube into the tubular members, the cutter having a cutting parameter; and
wherein the measuring act comprises:
cooling the tube in a bath; and
gauging the wall thickness without contacting the tube; and
gauging the wall thickness ultrasonically;
wherein the comparing act comprises:
calculating differences between the measured dimensions and the stored dimension targets;
calculating changes necessary to reduce the differences; and
generating the adjustment signal;
sorting tubular members into good tubular members or bad tubular members according to the stored dimension targets and according to stored error tolerances, the good tubular members having calculated measurement errors less than the stored error tolerances, the bad tubular member having calculated measurement errors greater than the stored error tolerances; and
removing the bad tubular members from the extrusion sequence; and
wherein the adjusting act comprises:
processing the adjustment signal into discrete feedback adjustment signals;
adjusting automatically any of the melt flow, the pressure, the tension, the flow rate, and the cutting parameter for the next tubular member according to the feedback adjustment signals; and
adjusting automatically according to adjustment signals representative of the measured dimensions measured in real time; and
wherein the method further comprises:
cutting the tube into discrete, substantially identical tubular members.

11. In a method for controlling the manufacture of dimensionally varying tubular members, the method comprising;
extruding a continuous tube with a lumen from an extrusion machine, the continuous tube comprising discrete, substantially identical tubular members in an extrusion sequence, each tubular member having inner diameter and outer diameter and a length, with a wall thickness between the inner diameter and the outer diameter, at least one of the inner diameter and the outer diameter varying as a function of the length, the extrusion machine comprising:
an extrusion head forming a melt flow and introducing a fluid within the melt flow to form the lumen of the tube;
a fluid pressure supplier which controls pressure of the introduced fluid;
a puller which supplies tension to the tube; and
a melt pump which regulates flow rate of the melt flow through the extrusion head;
the improvement comprising;
measuring automatically at least one of inner diameter, outer diameter and wall thickness along the length of the tubular member to determine measured dimensions for the tubular member;
comparing automatically the measured dimensions against stored dimension targets to generate an adjustment signal; and
adjusting automatically one or more process variables for a next tubular member in the extrusion sequence according to the adjustment signal.

12. The method of claim 11, the measuring act comprising,
measuring ultrasonically the wall thickness of the tubing in a bath at a rate of at least 1000 wall thickness measurements per inch of tubing.

13. The method of claim 12, the improvement further comprising:
optically scanning the profile of the tubing using a laser at a rate of at least 100 measurements per inch of tubing.

14. A method for controlling the manufacture of dimensionally varying tubular members, the method comprising:
extruding a continuous tube with a lumen from an extrusion machine, the continuous tube comprising discrete, substantially identical tubular members in an extrusion sequence, each tubular member having inner diameter and outer diameter and a length, with a wall thickness between the inner diameter and the outer diameter, at least one of the inner diameter and the outer diameter varying as a function of the length, the extrusion machine comprising:
an extrusion head forming a melt flow and introducing a fluid within the melt flow to form the lumen of the tube;
a fluid pressure supplier which controls pressure of the introduced fluid;
a puller which supplies tension to the tube;
a cutter which segments the tubing into substantially identical tubular members; and
a melt pump which regulates flow rate of the melt flow through the extrusion head;
measuring at least one of inner diameter, outer diameter, length and wall thickness along the length of the tubular member to determine measured dimensions for the tubular member;
comparing the measured dimensions against stored dimension targets to generate an adjustment signal; and
adjusting automatically one or more process variables for a next tubular member in the extrusion sequence according to the adjustment signal.

15. The method of claim 14 wherein the measuring act comprises:
cooling the tube in a bath; and
gauging the wall thickness without contacting the tube.

16. The method of claim 15, wherein the measuring act further comprises:
measuring ultrasonically the wall thickness of the tubular member in a bath; and
scanning optically the profile of the tubular member using a laser.

17. The method of claim 14 wherein the comparing act comprises:
calculating differences between the measured dimensions and the stored dimension targets;
calculating changes necessary to reduce the differences; and
generating the adjustment signal.

18. The method of claim 14 wherein the comparing act further comprises:
sorting tubular members into good tubular members or bad tubular members according to the stored dimension targets and according to stored error tolerances, the good tubular members having calculated measurement errors less than the stored error tolerances, the bad tubular member having calculated measurement errors greater than the stored error tolerances; and
removing the bad tubular members from the extrusion sequence.

19. The method of claim 14 wherein the adjusting act comprises,
processing the adjustment signal into discrete feedback adjustment signals;
adjusting automatically any of the melt flow, the pressure, the tension, the flow rate, and the cutting parameter according to the feedback adjustment signals.

20. The method of claim 19 wherein the adjusting act further comprises,
adjusting automatically according to adjustment signals representative of the measured dimensions measured in real time.
